(19) United States
(12) Patent Application Publication
(10) Pub. No.: US 2026/0132948 A1
(43) Pub. Date: May 14, 2026

(54) TREND ANALYSIS AND DATA MANAGEMENT SYSTEM FOR TEMPERATURE, PRESSURE, AND HUMIDITY COMPLIANCE

(71) Applicant: Tyco Fire & Security GmbH, Neuhausen am Rheinfall (CH)

(72) Inventors: Julie J. Brown, Yardley, PA (US); Renee R. Jacobs, Leawood, KS (US); Fawn R. Staerkel, Phoenix, AZ (US); Rachel D.M. Ellerman, Shorewood, WI (US); Tyler Brown, New Haven, CT (US)

(21) Appl. No.: 19/376,595

(22) Filed: Oct. 31, 2025

Related U.S. Application Data
(63) Continuation of application No. 17/024,387, filed on Sep. 17, 2020, now abandoned.
(60) Provisional application No. 62/902,338, filed on Sep. 18, 2019.

(51) Int. Cl. F24F 11/64; F24F 11/30; F24F 11/32; F24F 11/38; F24F 11/523; F24F 11/58; F24F 110/10; F24F 110/20; F24F 110/40; G05B 19/042; G06N 5/02; G06Q 10/0631; G06Q 10/0639; G06Q 10/20; G06Q 30/018; G06Q 50/163

(52) U.S. Cl. CPC F24F 11/64; F24F 11/30; F24F 11/32; F24F 11/38; F24F 11/523; F24F 11/58; G05B 19/042; G06N 5/02; G06Q 10/0631; G06Q 10/06395; G06Q 10/20; G06Q 30/018; G06Q 50/163; F24F 2110/10; F24F 2110/20; F24F 2110/40; G05B 2219/25011; G05B 2219/2614

(57) ABSTRACT

A building management system (BMS) includes a sensor array structured to provide sensor data indicative of temperature, pressure, and humidity in an interior space, and one or more processing circuits configured to execute stored instructions to receive the sensor data from the sensor array, generate, based on the sensor data, trend data indicative of the temperature, pressure, and humidity of the interior space over a period of time, generate, based on the trend data, a prediction of future trend data for the interior space, compare the sensor data and the prediction to a compliance standard, and initiate an automated response process in response to a determining that at least one of the sensor data or the prediction does not meet the compliance standard.

### CROSS-REFERENCE TO RELATED PATENT APPLICATIONS

This application is a continuation of U.S. patent application Ser. No. 17/024,387, filed on Sep. 17, 2020, which claims the benefit of and priority to U.S. Provisional Patent Application No. 62/902,338, filed Sep. 18, 2019, the entire disclosures of which are incorporated by reference herein.

### BACKGROUND

The present disclosure relates to systems and methods of controlling temperature, humidity, and pressure (TPH) within a room and/or a building. In some cases, TPH for a room and/or a building is monitored and checked for compliance with regulations or process controls. Regulations may include standards set by governmental or non-governmental entities and compliance may be checked by a compliance officer. Checks for compliance of TPH may be checked randomly or on a set routine or schedule and can affect the ability of the building to continue operation (e.g., an out of compliance hospital may be inhibited from providing patient care).

In some embodiments, particularly for a building that serves as a hospital, The Joint Commission (TJC) may administer the compliance checks. In some such embodiments, if the hospital building or a room within the building (e.g., a patient room, an operating room, etc.) is found to be out of compliance, a finding is identified and reported to the Centers for Medicare and Medicaid Services (CMS), who then perform an independent inspection of the building or room. Should the building or room fail the CMS inspection, a deemed status of the hospital may be lost. The loss of deemed status can result in the withholding of Medicare and/or Medicaid to the hospital. In a hospital setting, response to issues affecting TPH in a timely manner is critical. A system for monitoring TPH and related factors could improve a hospital's ability to pass inspections and maintain a healthy environment for patient care.

### SUMMARY

One embodiment of the present disclosure is a building management system (BMS). The BMS includes a sensor array structured to provide sensor data indicative of temperature, pressure, and humidity in an interior space and one or more memory devices having instructions stored thereon that, when executed by one or more processors, cause the one or more processors to perform operations including receiving the sensor data from the sensor array, generating, based on the sensor data, trend data indicative of the temperature, pressure, and humidity of the interior space over a period of time, generating, based on the trend data, a prediction of future trend data for the interior space, comparing at least one of the sensor data or the prediction to a compliance standard, and initiating an automated response process in response to a determining that at least one of the sensor data or the prediction does not meet the compliance standard.

In some embodiments, the operations further include determining a confidence level for the prediction, and comparing the confidence level to a predetermined threshold. In some embodiments, the automated response process is initiated when the confidence level is greater than or equal to the predetermined threshold.

In some embodiments, the operations further include generating a report summarizing the trend data and providing a time range when the sensor data is predicted to not meet the compliance standard.

In some embodiments, the automated response process includes controlling one or more primary building devices to affect at least one of the temperature, pressure, or humidity of the interior space based on the compliance standard.

In some embodiments, the automated response process includes generating a notification that indicates at least one building device associated with the at least one of the sensor data or the prediction that does not meet the compliance standard and transmitting the notification to a user device.

In some embodiments, the automated response process includes generating a work order for at least one building device associated with the at least one of the sensor data or the prediction that does not meet the compliance standard and transmitting the work order to at least one of a remote system or a user device.

In some embodiments, generating the prediction includes executing a predictive model to generate a first prediction of future trend data and determining, based on the first prediction of future trend data, a second prediction indicating a future compliance issue for a building device.

In some embodiments, the sensor data is first sensor data, the operations further include controlling one or more primary building devices based on at least one of the sensor data or the prediction, receiving second sensor data from the sensor array, comparing the second sensor data to the compliance standard to determine a reward value, and updating the predictive model based on the reward value.

In some embodiments, the operations further include training the predictive model using historical temperature, pressure, and humidity data for the interior space.

Another embodiment of the present disclosure is a method for maintaining compliance of building equipment. The method includes receiving sensor data from a sensor array located in an area of a building, generating, based on the sensor data, trend data indicative of the temperature, pressure, and humidity of the area over a period of time, generating, based on the trend data, a prediction of future trend data for the area, comparing at least one of the sensor data or the prediction to a compliance standard, and initiating an automated response process in response to a determining that at least one of the sensor data or the prediction does not meet the compliance standard. The automated response including a preemptive action that controls a heating, ventilation, or air conditioning system based on the trend data to maintain the temperature, pressure, and humidity within the compliance standard.

In some embodiments, the method further includes determining a confidence level for the prediction and comparing the confidence level to a predetermined threshold. In some embodiments, the automated response process is initiated when the confidence level is greater than or equal to the predetermined threshold.

In some embodiments, the method further includes generating a report summarizing the trend data and providing a time range when the sensor data is predicted to not meet the compliance standard.

In some embodiments, the automated response process includes controlling one or more primary building devices to affect at least one of the temperature, pressure, or humidity of the area based on the compliance standard.

In some embodiments, the automated response process includes generating a notification that indicates at least one building device associated with the at least one of the sensor data or the prediction that does not meet the compliance standard and transmitting the notification to a user device.

In some embodiments, the automated response process includes generating a work order for at least one building device associated with the at least one of the sensor data or the prediction that does not meet the compliance standard and transmitting the work order to at least one of a remote system or a user device.

In some embodiments, generating the prediction includes executing a predictive model to generate a first prediction of future trend data and determining, based on the first prediction of future trend data, a second prediction indicating a future compliance issue for a building device.

In some embodiments, the sensor data is first sensor data and the method further includes controlling one or more primary building devices based on at least one of the sensor data or the prediction, receiving second sensor data from the sensor array, comparing the second sensor data to the compliance standard to determine a reward value, and updating the predictive model based on the reward value.

In some embodiments, the method further includes training the predictive model using historical temperature, pressure, and humidity data for the area.

Yet another embodiment of the present disclosure is a non-transitory computer-readable storage media having computer-executable instructions stored thereon that, when executed by one or more processors, cause the one or more processors to perform operations that include receiving sensor information over time from a sensor array located in an interior space of a building, receiving operational parameters from one or more primary building devices, generating trend data indicative of the temperature, pressure, and humidity of the interior space over a period of time using a machine learning engine that receives the sensor information and the operational parameters, generating a future trend prediction of future trend data for the interior space using the machine learning engine, comparing the future trend prediction to a compliance standard, generating a predicted future compliance issue based on the comparison of the future trend prediction to the compliance standard, determining a confidence level for the predicted future compliance issue, and in response to a determination that the confidence level is greater than or equal to a predetermined threshold, initiating an automated response process.

In some embodiments, the automated response process includes at least one of transmitting a notification to a user device, generating a work order for one or more building devices associated with the predicted future compliance issue, or controlling the more or more building device to prevent the predicted future compliance issue.

### BRIEF DESCRIPTION OF THE DRAWINGS

Objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a HVAC system, according to some embodiments.

FIG. 2 is a block diagram of a waterside system that may be used in conjunction with the building of FIG. 1, according to some embodiments.

FIG. 3 is a block diagram of an airside system that may be used in conjunction with the building of FIG. 1, according to some embodiments.

FIG. 4 is a block diagram of a building management system (BMS) that may be used to monitor and/or control the building of FIG. 1, according to some embodiments.

FIG. 5 is a block diagram of a data management system for the BMS of FIG. 4 and one or more remote systems, according to some embodiments.

FIG. 6A is a block diagram of a room including a sensor array, according to some embodiments.

FIG. 6B is a block diagram of a controller for trend analysis and data management, according to some embodiments.

FIG. 7 is a block diagram of a data management system for a building, according to some embodiments.

FIG. 8A is a flow diagram of a process for aggregating data from one or more areas of a building, according to some embodiments.

FIG. 8B is a flow diagram of a process for analyzing data for at least one area of a building, according to some embodiments.

FIG. 9 is a flow diagram of a process for monitoring compliance of a BMS subsystem, according to some embodiments.

FIG. 10 is a flow diagram of a process for predicting non-compliance of BMS subsystems using a predictive model, according to some embodiments.

### DETAILED DESCRIPTION

Referring generally to the FIGURES, a system and methods for trend analysis and data management for a BMS are shown, according to some embodiments. More specifically, the system and methods described herein can be implemented to monitor parameters of areas within a building or other facility (e.g., a hospital), in order to identify potentially compliance issues. As described herein, compliance issues may generally refer to any indication of non-compliance, where one or more parameters of an area or a building do not meet a set of compliance standards (e.g., standard or predetermined values). The parameters generally include at least temperature, pressure, and humidity (TPH) of a room, area, or building.

In some embodiments, the systems and methods described herein may be applied to rooms or spaces within a hospital or another industrial building where TPH must be monitored and checked for compliance with regulations or process controls. As described above, compliance regulations may include standards set by governmental or non-governmental entities and compliance may be checked by a compliance officer. Checks for compliance of TPH may be checked randomly or on a set routine or schedule and can affect the ability of the building to continue operation (e.g., an out of compliance hospital may be inhibited from providing patient care). In some cases, a third party may administer the compliance checks and/or may establish compliance standards.

The systems and methods described herein may continually monitor TPH measurements from any number of rooms or areas within a building (e.g., a hospital). The TPH data may be used to generate trend data that indicated TPH measurements for a room or area over time. In some embodiments, the trend data may be analyzed using a predictive model to predict future non-compliance issues. Additionally, in some embodiments, TPH data from one or more sensors can be compared to a compliance standard to detect compliance issues in real-time. If a room or building falls out of compliance, or if future non-compliance is predicted, automated response process can be implemented. In this regard, the systems and methods described herein for trend analysis and data management can help a facility (e.g., a hospital) maintain compliance standards to decrease downtime due to compliance issues and, in some cases, to decrease or avoid equipment faults. Additional features and advantages of the present disclosure are described in greater detail below.

Building with Building Systems

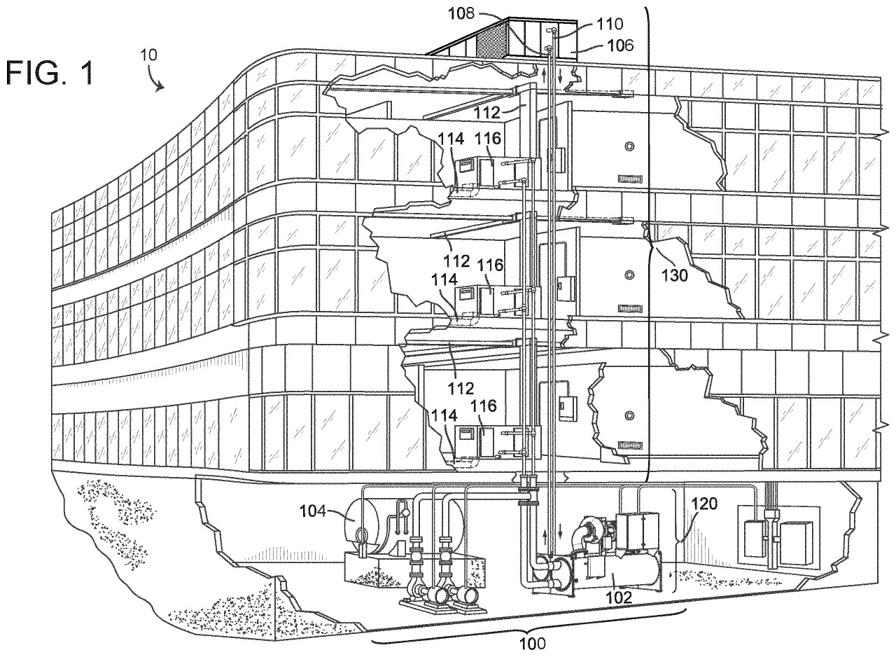

Referring now to FIGS. 1-4, an exemplary building management system (BMS) and HVAC system in which the systems and methods of the present disclosure can be implemented are shown, according to some embodiments. Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire safety system, any other system that is capable of managing building functions or devices, or any combination thereof.

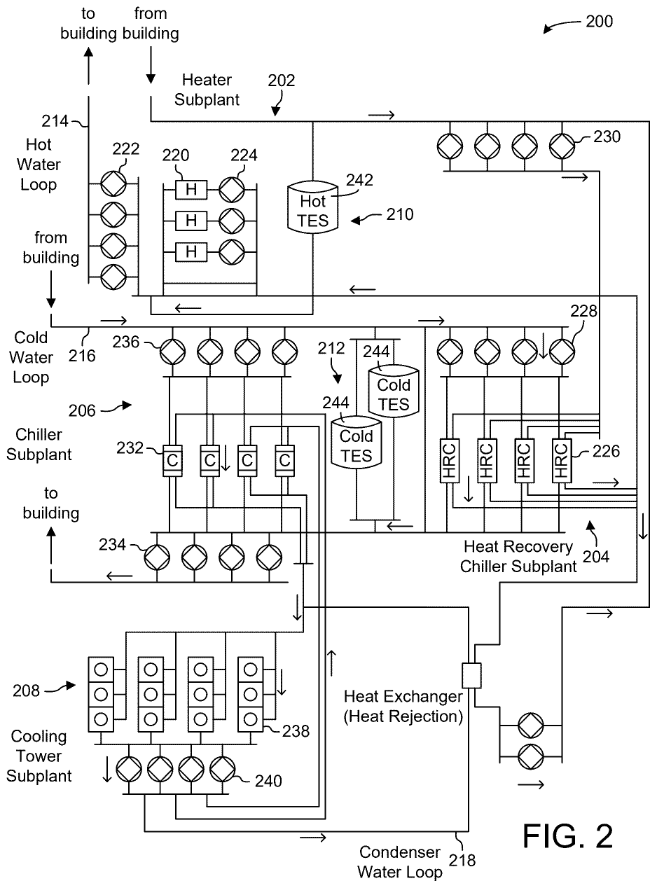

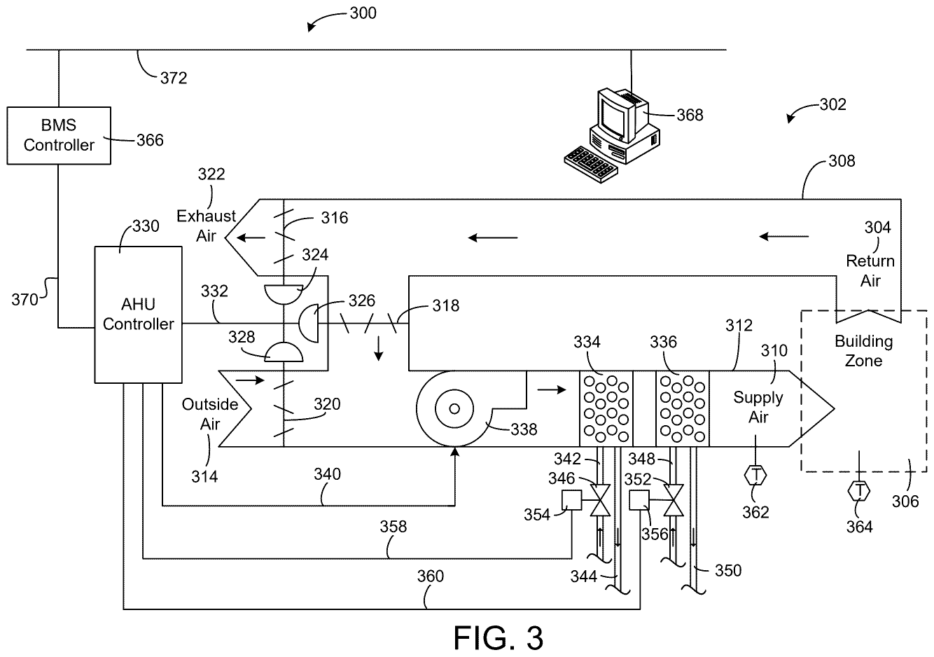

The BMS that serves building 10 includes an HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 can provide a heated or chilled fluid to an air handling unit of airside system 130. Airside system 130 can use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 can use boiler 104 and chiller 102 to heat or cool a working fluid (e.g., water, glycol, etc.) and can circulate the working fluid to AHU 106. In embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 can add heat to the circulated fluid, for example, by burning a combustible material (e.g., natural gas) or using an electric heating element. Chiller 102 can place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 can place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 can transfer heat between the airflow and the working fluid to provide heating or cooling for the airflow. For example, AHU 106 can include one or more fans or blowers configured to pass the airflow over or through a heat exchanger containing the working fluid. The working fluid can then return to chiller 102 or boiler 104 via piping 110.

Airside system 130 can deliver the airflow supplied by AHU 106 (i.e., the supply airflow) to building 10 via air supply ducts 112 and can provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include sensors (e.g., temperature sensors, pressure sensors, etc.) configured to measure attributes of the supply airflow. AHU 106 can receive input from sensors located within AHU 106 and/or within the building zone and can adjust the flow rate, temperature, or other attributes of the supply airflow through AHU 106 to achieve setpoint conditions for the building zone.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve the thermal energy loads (e.g., hot water, cold water, heating, cooling, etc.) of a building or campus. For example, heater subplant 202 may be configured to heat water in a hot water loop 214 that circulates the hot water between heater subplant 202 and building 10. Chiller subplant 206 may be configured to chill water in a cold water loop 216 that circulates the cold water between chiller subplant 206 building 10. Heat recovery chiller subplant 204 may be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air may be delivered to individual zones of building 10 to serve the thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) may be used in place of or in addition to water to serve the thermal energy loads. In other embodiments, subplants 202-212 may provide heating and/or cooling directly to the building or campus without requiring an intermediate heat transfer fluid. These and other variations to waterside system 200 are within the teachings of the present invention.

Each of subplants 202-212 may include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves may be integrated with the pumps or positioned upstream or downstream of the pumps to control the fluid flows in waterside system 200. In embodiments, waterside system 200 may include more, fewer, or different types of devices and/or subplants based on the particular configuration of waterside system 200 and the types of loads served by waterside system 200.

Referring now to FIG. 3, a block diagram of an airside system 300 is shown, according to some embodiments. In embodiments, airside system 300 may supplement or replace airside system 130 in HVAC system 100 or may be implemented separate from HVAC system 100. When implemented in HVAC system 100, airside system 300 may include a subset of the HVAC devices in HVAC system 100 (e.g., AHU 106, VAV units 116, ducts 112-114, fans, dampers, etc.) and may be located in or around building 10. Airside system 300 may operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 may be configured to operate exhaust air damper 316, mixing damper 318, and outside air damper 320 to control an amount of outside air 314 and return air 304 that combine to form supply air 310. Any return air 304 that does not pass through mixing damper 318 may be exhausted from AHU 302 through exhaust damper 316 as exhaust air 322.

Each of dampers 316-320 may be operated by an actuator. For example, exhaust air damper 316 may be operated by actuator 324, mixing damper 318 may be operated by actuator 326, and outside air damper 320 may be operated by actuator 328. Actuators 324-328 may communicate with an AHU controller 330 via a communications link 332. Actuators 324-328 may receive control signals from AHU controller 330 and may provide feedback signals to AHU controller 330. Feedback signals may include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that may be collected, stored, or used by actuators 324-328. AHU controller 330 may be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 may be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from waterside system 200 (e.g., from cold water loop 216) via piping 342 and may return the chilled fluid to waterside system 200 via piping 344. Valve 346 may be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 may receive a heated fluid from waterside system 200 (e.g., from hot water loop 214) via piping 348 and may return the heated fluid to waterside system 200 via piping 350. Valve 352 may be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 may be controlled by an actuator. For example, valve 346 may be controlled by actuator 354 and valve 352 may be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 may control the temperature of supply air 310 and/or building zone 306 by activating or deactivating coils 334-336, adjusting a speed of fan 338, or a combination of both.

Still referring to FIG. 3, airside system 300 is shown to include a building automation system (BMS) controller 366 and a client device 368. BMS controller 366 may include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 may communicate with multiple downstream building systems or subsystems (e.g., HVAC system 100, a security system, a lighting system, waterside system 200, etc.) via a communications link 370 according to like or disparate protocols (e.g., LON, BACnet, etc.). In embodiments, AHU controller 330 and BMS controller 366 may be separate (as shown in FIG. 3) or integrated. In an integrated implementation, AHU controller 330 may be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 may provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 may include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 may be a computer workstation, a client terminal, a remote or local interface, or any other type of user interface device. Client device 368 may be a stationary terminal or a mobile device. For example, client device 368 may be a desktop computer, a computer server with a user interface, a laptop computer, a tablet, a smartphone, a PDA, or any other type of mobile or non-mobile device. Client device 368 may communicate with BMS controller 366 and/or AHU controller 330 via communications link 372.

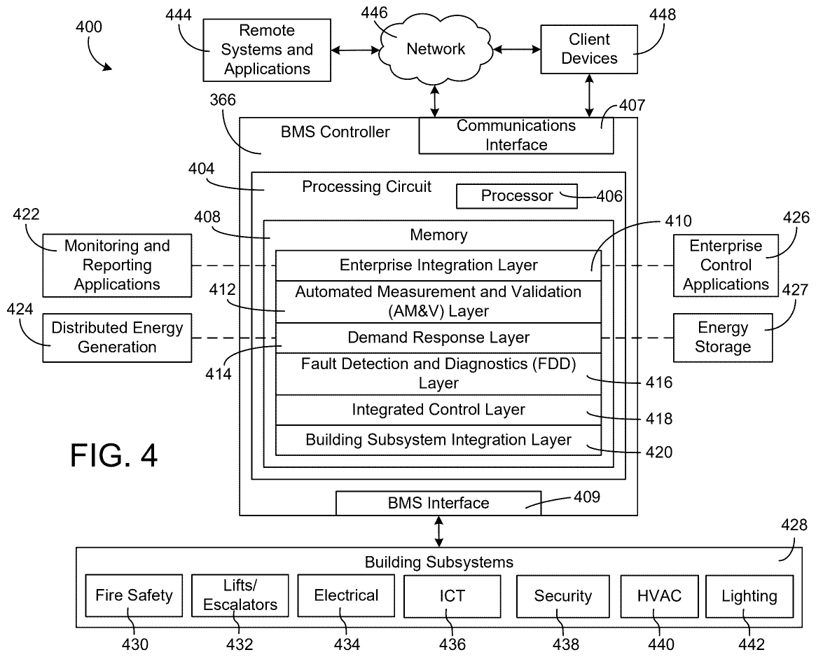

Referring now to FIG. 4, a block diagram of a building automation system (BMS) 400 is shown, according to some embodiments. BMS 400 may be implemented in building 10 to automatically monitor and control building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2-3.

Each of building subsystems 428 may include any number of devices, controllers, and connections for completing its individual functions and control activities. HVAC subsystem 440 may include many of the same components as HVAC system 100, as described with reference to FIGS. 1-3. For example, HVAC subsystem 440 may include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 may include any number of light fixtures, ballasts, lighting sensors, dimmers, or other devices configured to controllably adjust the amount of light provided to a building space. Security subsystem 438 may include occupancy sensors, video surveillance cameras, digital video recorders, video processing servers, intrusion detection devices, access control devices and servers, or other security-related devices.

Still referring to FIG. 4, BMS controller 366 is shown to include a communications interface 407 and a BMS interface 409. Interface 407 may facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 may also facilitate communications between BMS controller 366 and client devices 448. BMS interface 409 may facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In embodiments, communications via interfaces 407, 409 may be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a WiFi transceiver for communicating via a wireless communications network. In another example, one or both of interfaces 407, 409 may include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 may be communicably connected to BMS interface 409 and/or communications interface 407 such that processing circuit 404 and the components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) may include one or more devices (e.g., RAM, ROM, Flash memory, hard disk storage, etc.) for storing data and/or computer code for completing or facilitating the processes, layers and modules described in the present application. Memory 408 may be or include volatile memory or non-volatile memory. Memory 408 may include database components, object code components, script components, or any other type of information structure for supporting the activities and information structures described in the present application. According to an exemplary embodiment, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In other embodiments BMS controller 366 may be distributed across multiple servers or computers (e.g., that can exist in distributed locations). Further, while FIG. 4 shows applications 422 and 426 as existing outside of BMS controller 366, in some embodiments, applications 422 and 426 may be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 may be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 may be configured to serve clients or local applications with information and services to support a variety of enterprise-level applications. For example, enterprise control applications 426 may be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at interface 407 and/or BMS interface 409.

Building subsystem integration layer 420 may be configured to manage communications between BMS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 may be configured to optimize resource usage (e.g., electricity use, natural gas use, water use, etc.) and/or the monetary cost of such resource usage in response to satisfy the demand of building 10. The optimization may be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BMS controller 366 (e.g., building subsystem integration layer 420, integrated control layer 418, etc.). The inputs received from other layers may include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to an exemplary embodiment, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models may include, for example, thermodynamic models describing the inputs, outputs, and/or functions performed by sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions may be edited or adjusted by a user (e.g., via a graphical user interface) so that the control actions initiated in response to demand inputs may be tailored for the user's application, desired comfort level, particular building equipment, or based on other concerns. For example, the demand response policy definitions can specify which equipment may be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 may be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated super-system. In an exemplary embodiment, integrated control layer 418 includes control logic that uses inputs and outputs from a plurality of building subsystems to provide greater comfort and energy savings relative to the comfort and energy savings that separate subsystems could provide alone. For example, integrated control layer 418 may be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 may be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 may be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 may be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 may be configured to provide calculated inputs (e.g., aggregations) to these higher levels based on outputs from more than one building subsystem.

Automated measurement and validation (AM&V) layer 412 may be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 may be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 may be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults may include providing an alert message to a user, a maintenance scheduling system, or a control algorithm configured to attempt to repair the fault or to work-around the fault.

FDD layer 416 may be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to an exemplary embodiment, FDD layer 416 (or a policy executed by an integrated control engine or business rules engine) may shut-down systems or direct control activities around faulty devices or systems to reduce energy waste, extend equipment life, or assure proper control response.

FDD layer 416 may be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 400 and the components thereof. The data generated by building subsystems 428 may include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

### Trend Analysis and Data Management

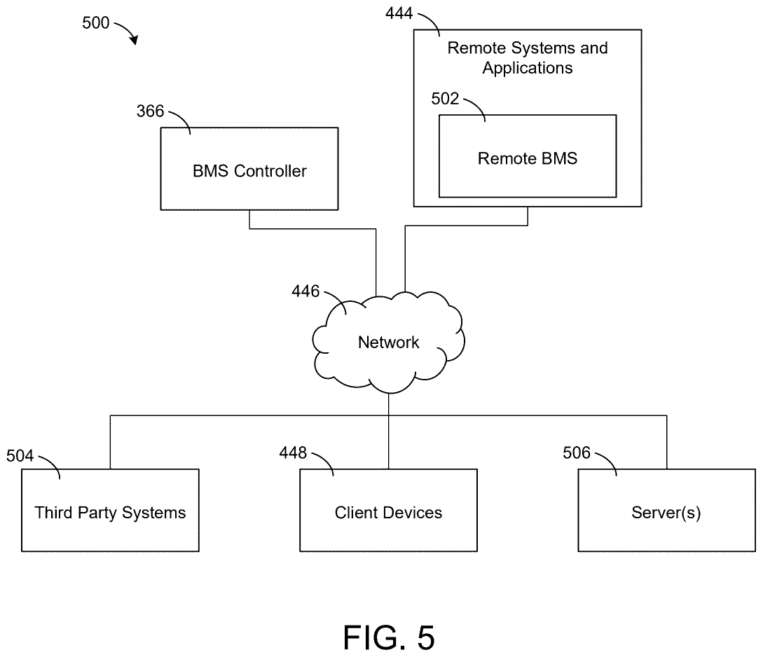

As shown in FIG. 5, a block diagram of a data management system 500 for the BMS 400 and one or more remote system or applications 444 is shown, according to some embodiments. As shown, the system 500 centers around the network 446, as briefly described above. The network 446 can be any sort of local or wide-area network (e.g., LAN, WAN, WLAN, MAN, CAN, etc.) that allows the components of the system 500 to exchange information (i.e., data). In some embodiments, the network 446 is an internal network or intranet (e.g., an internal BMS network). In other embodiments, the network 446 the Internet or other similar external network. In some such embodiments, components of the system 500 may communicate via the network 446 using a virtual private network (VPN) or other similar connection.

As also described above, the BMS controller 366 and one or more remote systems and applications 444 may be communicably coupled via the network 446. In the example of the system 500 shown in FIG. 5, the remote systems and applications 444 can include at least one remote BMS or BMS controller, shown as a remote BMS 502, although it will be appreciated that the BMS controller 366 can interface with any number of external or remote systems. Accordingly, the network 446 allows the BMS controller 366 to exchange data with the remote BMS 502. In embodiments, the remote BMS 502 is a secondary BMS or BMS controller for a building that is also served by the BMS 400, or the remote BMS 502 is a BMS or BMS controller for another building managed by a single entity. For example, the remote BMS 502 may be a BMS for a second building of a campus or facility, or may be a BMS for a building at a location that is remote from the building served by BMS 400. In these examples, both the BMS controller 366 and the remote BMS 502 can be accessed or “linked” by a single entity, such as a facility or site manager or management system.

Also communicably coupled to the BMS controller 366 and/or the remote BMS 502 via the network 446 are third party systems 504. The third party systems 504 can include any remote and/or external systems that are not necessarily part of the BMS 400. In other words, the third party systems 504 are generally systems that are hosted, maintained, or otherwise operated by computing devices and/or users outside of an organization associated with the BMS 400 (e.g., the BMS controller 366 and the remote systems and applications 444).

In one example, the third party systems 504 may include an external website, server, or system associated with a utilities provider (e.g., to provide electricity, water, etc.). In this example, the utility provider's system may exchange data relating to utility rates, usage, etc. In another example, such as when the system 500 and/or the BMS 400 are implemented in a hospital, the third party systems 504 can include at least The Joint Commission (TJC) and the Centers for Medicare & Medicaid Services (CMS) to allow for communication between a network of hospitals and the regulating bodies. Accordingly, as described in greater detail below, the third party systems 504 can access operational data via the network 446 to perform compliance checks. It will be appreciated that in other embodiments, the third party systems 504 include any other systems that are not operated by the same organization as the BMS 400.

The system 500 is also shown to include client devices 448. As described above, the client devices 448 can include one or more individual client or user devices (e.g., client device 368). The client devices 448 generally allow a user to interact with the BMS controller 366 and/or the remote systems and applications 444. The client devices 448 can include one or more devices such as tablets, computers, smart phones, access points, interactive wall panels, augmented reality devices, smart watches, virtual reality devices, glasses, commercial human machine interfaces, etc., that provide an interface for a user.

In some embodiments, one or more large scale memory devices in the form of servers 506 are also communicably coupled to the network 446. The servers 506 can be implemented in a variety of ways. For example, the servers 506 may include one or more network devices such as a network engine or a controller similar to the BMS controller 366. The servers 506 may also be workstations, personal computers, or another type of device similar to the client device 368 discussed above with server software installed thereon. The servers 506 may also be implemented using one or more on-premises server computers and/or one or more remote cloud-based server computers. In this sense, the servers 506 may be distributed across a variety of physical hardware devices.

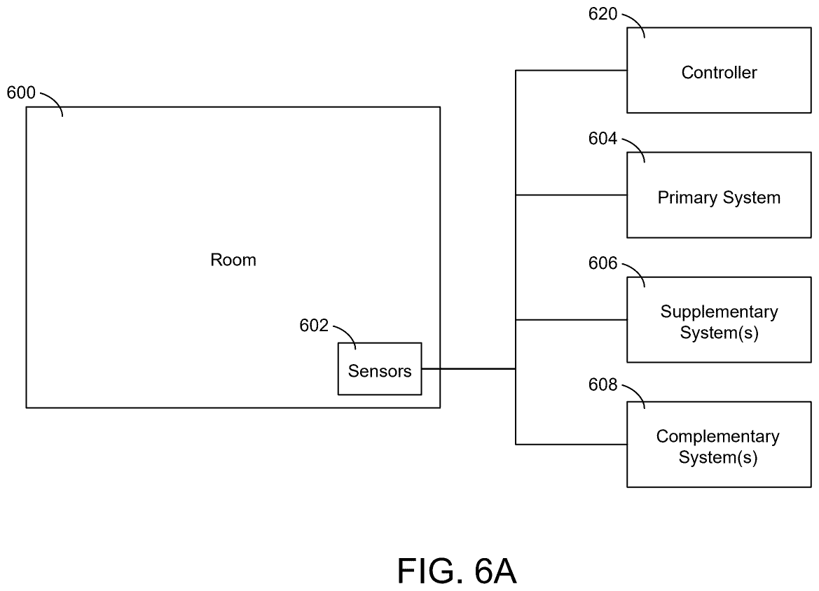

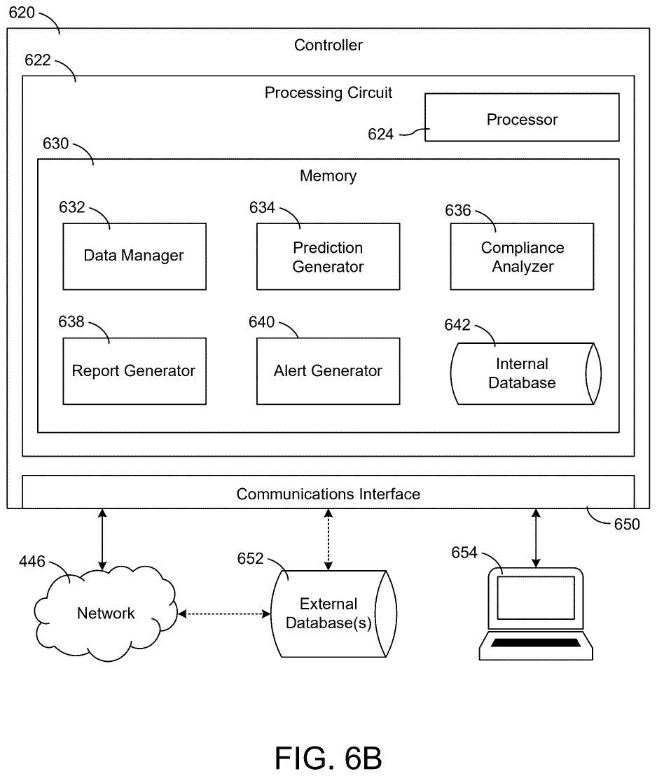

Referring now to FIG. 6A, a block diagram of a room 600 including a sensor array 602 is shown, according to some embodiments. The room 600 is generally any defined area within a building that is fitted with one or more sensors for measuring parameters within the room 600. Accordingly, the room 600 may be any room of a building that is served by the BMS 400. In this regard, the room 600 may also include one or more building devices associated with any of the building subsystems 428, such as fire safety devices, HVAC devices, lighting devices, etc. In some embodiments, the room 600 can be any space for which TPH performance or compliance is desirable. In some embodiments, the room 600 is an operating room, a patient room, or a common area of a hospital. In some embodiments, the room 600 is a clean room for an industrial, food processing, or pharmaceutical process.

The sensor array 602 can include any number of sensors for measuring any of a variety of parameters associated with the room 600 and/or the building subsystem devices associated with the room 600. The sensor array 602 can include, for example, humidity sensors, temperature sensors, pressure sensors, and other sensors. In some embodiments, the sensor array 602 includes fire/smoke alarms, door sensors, occupancy sensors, thermal cameras, air quality sensors, and/or other sensors that measure factors indicative of an environment within the room 600. In some embodiment, such as when the room 600 is an operating room or a patient room in a hospital, the sensor array 602 includes any sensors that are necessary to ensure patient comfort and safety, and to monitor/maintain an environment that meets compliance standards for hospitals. In general, the sensor array 602 includes sensors configured to measure at least a temperature, a pressure, and a humidity (TPH) of the room 600.

As shown in FIG. 6A, a primary system 604 and a supplementary system 606 are communicably coupled to the sensor array 602. In this manner, the primary system 604 and/or the supplementary system 606 may receive sensor data from the sensor array 602. In general, the primary system 604 and/or the supplementary system 606 are structured to control an environment within the room 600. Accordingly, the primary system 604 and/or the supplementary system 606 can include at least a portion of any of the building subsystems 428 described above. The primary system 604 and/or the supplementary system 606 may be configured to affect at least a temperature, pressure, and humidity of the room 600. In other words, the primary system 604 and/or the supplementary system 606 can affect or control the environment within the room 600.

In some embodiments, the primary system 604 includes HVAC equipment (e.g., of the HVAC subsystem 440) capable of affecting the environment of the room 600 (e.g., by controlling or adjusting the temperature, pressure, and humidity). For example, the primary system 604 can include at least the waterside system 120 and/or the airside system 130 discussed above. In some embodiments, the primary system 604 is a single component (e.g., a heater, a chiller, an AHU, a pump, etc.), while in other embodiments, the primary system 604 can include any number of devices (e.g., one or more devices of the HVAC subsystem 440, described above) or systems (e.g., the HVAC system servicing a group of rooms collectively).

The supplementary system 606 is generally an additional (e.g., backup) system that supplements or replaces the primary system 604. In this regard, the supplementary system 606 can include one or more devices that are functionally similar to, or identical to, the devices of the primary system 604. For example, if the primary system 604 includes an AHU (e.g., the AHU 106) and one or more chillers (e.g., the chiller 102), then supplementary system may also include a similarly sized AHU and chillers.

In some embodiments, one or more complementary systems 608 are also associated with the room 600, and thereby coupled to the sensor array 602. The complementary systems 608 can generally include any additional subsystems (e.g., of the building subsystems 428) or building devices that are not included in the primary system 604 or the supplementary system 606. In some embodiments, the complementary systems 608 include any subsystems or devices that are not associated with controlling or monitoring the environment within the room 600, and more specifically the temperature, pressure, and humidity of the room 600. For example, the complementary systems 608 can include a fire suppression system, a security system, a utility system (e.g., electricity, gas, etc.), and/or any another system related to the operation of the room 600.

As shown in FIG. 6B, a block diagram of a controller 620 for trend analysis, data management, and report facilitation is shown, according to some embodiments. In general, the controller 620 can automatically monitor parameters of a room (e.g., the room 600) or rooms of a building over time, and generate reports that improve a compliance review process. As described above, for example, parameters such as temperature, pressure, and humidity (TPH) of a room or rooms can be monitored to detect non-compliance. In a hospital setting, for example, predetermined compliance standards may be set by The Joint Commission (TJC) or by the Centers for Medicare & Medicaid Services (CMS), and the controller 620 may at least partially automate the process of monitoring TPH for rooms or areas of the hospital based on the predetermined compliance standards and compiling compliance reports. Additionally, the controller 620 may determine that one or more parameters (e.g., TPH) of a room are falling out of compliance, or may become non-compliant in the near future, and can take appropriate actions to avoid non-compliance.

The controller 620 is communicably coupled to the sensor array 602 and the primary system 604, the supplementary system 606, and the complementary systems 608. In this regard, the controller 620 may receive data regarding one or more parameters of the room 600 from the sensor array 602, analyze or process the data, and control one or more of the primary system 604, the supplementary system 606, or the complementary systems 608 based on the data. In some embodiments, the controller 620 may also receive operating data from any of the primary system 604, the supplementary system 606, or the complementary systems 608. In embodiments, the controller 620 may be coupled to the sensor array 602, the primary system 604, the supplementary system 606, or the complementary systems 608 either directly (e.g., through a wired connection) or indirectly (e.g., via the network 446).

The controller 620 may exchange data with any of the sensor array 602, the primary system 604, the supplementary system 606, or the complementary systems 608 via a communications interface 650. The communications interface 650 may be configured to facilitate the exchange (i.e., sending and receiving) of data between the controller 620 and one or more other components. For example, the communications interface 650 may be configured to exchange data via the network 446 and may include appropriate interfaces for communicating on the network 446. For example, the communications interface 650 may include a wired and/or wireless interface for connecting the controller 620 to the Internet, or to an intranet. In some embodiments, the communications interface 650 provides an interface between the controller 620 any one or more the building subsystems 428, or other components of the BMS 400. In this regard, the communications interface 650 can include a BACnet interface in addition to other types of communications interfaces (e.g., Modbus, LonWorks, DeviceNet, XML, etc.).

In some embodiments, the communications interface 650 facilitates communication between the controller 620 and one or more external databases 652. In some such embodiments, data may be exchanged directly with external databases 652, or indirectly through the network 446. The external databases 652 can be implemented in a variety of ways. For example, the external databases 652 may include one or more memory devices or remote storage devices. The external databases 652 may also include workstations, personal computers, servers (e.g., the servers 506), etc., and may include one or more on-premises server computers/databases and/or one or more cloud-based databases. In this sense, the external databases 652 may be distributed across a variety of physical hardware devices.

As shown, the communications interface 650 also facilitates communication between the controller 620 and at least one user device 654. The user device 654 may be any electronic device that allows a user to interact with the controller 620 through a user interface. Examples of user devices include, but are not limited to, mobile phones, electronic tablets, laptops, desktop computers, workstations, and other types of electronic devices. The user device 654 may be similar to the client device 368 and/or the client devices 448, as described above. The user device 654 may display graphical user interfaces or other data on a display, thereby enabling a user to easily view data and interact with the controller 620.

Still referring to FIG. 6B, the controller 620 includes a processing circuit 622, which further includes a processor 624 and memory 630. It will be appreciated that these components can be implemented using a variety of different types and quantities of processors and memory. The processing circuit 622 can be communicably connected to the communications interface 650 such that processing circuit 622 and the components thereof can send and receive data via the communications interface 650. The processor 624 can be implemented as a general purpose processor, an application specific integrated circuit (ASIC), one or more field programmable gate arrays (FPGAs), a group of processing components, or other suitable electronic processing components.

The memory 630 (e.g., memory, memory unit, storage device, etc.) can include one or more devices (e.g., RAM, ROM, Flash memory, hard disk storage, etc.) for storing data and/or computer code for completing or facilitating the processes, layers and modules described in the present application. The memory 630 can be or include volatile memory or non-volatile memory. The memory 630 can include database components, object code components, script components, or any other type of information structure for supporting the activities and information structures described in the present application. According to an example embodiment, the memory 630 is communicably connected to the processor 624 via the processing circuit 622 and includes computer code for executing (e.g., by the processing circuit 622 and/or the processor 624) one or more processes described herein.

In some embodiments, the controller 620 is implemented within a single computer (e.g., one server, one housing, etc.). In other embodiments the controller 620 can be distributed across multiple servers or computers (e.g., that can exist in distributed locations). In some embodiments, the controller 620 is embodied in the BMS 400 as described above, and accordingly, the processing circuit 622, the processor 624, and/or the memory 630 may be similar to or the same as the processing circuit 404, the processor 406 and/or the memory 408 as described above. Additionally, in such embodiments, the components of the memory 630, described below, may be embodied in the BMS 400. In other embodiments, the controller 620 is a stand-alone device or component not embodied in the BMS 400, and therefore includes its own dedicated processing circuit 622, processor 624, and/or memory 630. In yet other embodiments, the controller 620 is embodied as a portion of the BMS 400, a differently arranged BMS, or a building automation system (BAS), and accordingly may share a processing circuit, processor, and/or memory with any of these other BMSs or BASs.

The memory 630 is shown to include a data manager 632. The data manager 632 may be configured for a variety of functions including exchanging data via the communications interface 650, aggregating received data, and managing data storage. More particularly, the data manager 632 may be configured to receive data from building equipment and sensors (e.g., the sensor array 602), and in some cases may preprocess the data (e.g., reformatting the data, removing outliers, time stamp the data, etc.). In some embodiments, the data received by the data manager 632 from the sensor array 602 includes at least TPH data for an area of a building (e.g., the room 600).

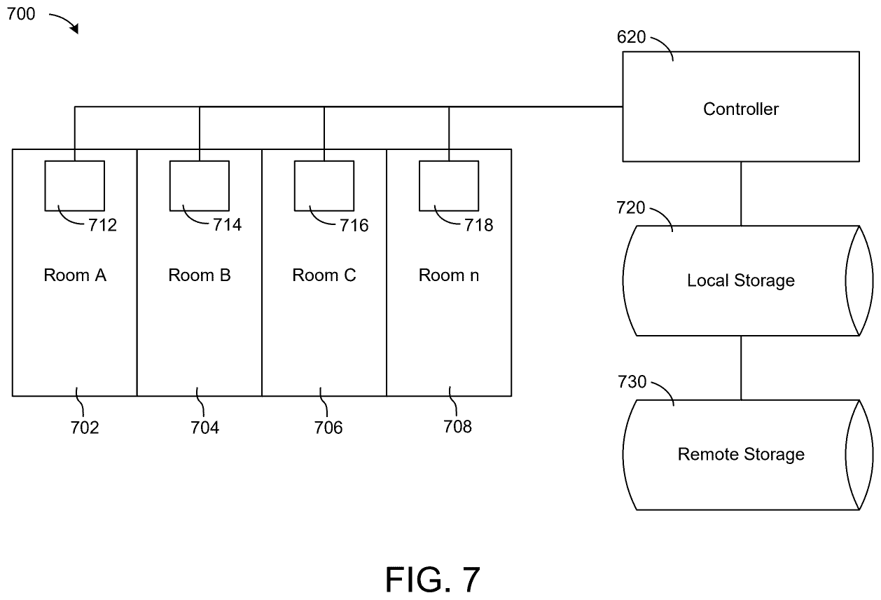

In some embodiments, the data manager 632 can aggregate data received from one or more sensors or devices. For example, a building with multiple rooms may include multiple sensor arrays, such as described below with respect to FIG. 7. Accordingly, the data manager 632 may aggregate data received from these multiple sensor arrays in order to provide a complete data set for a building. In some embodiments, the data manager 632 receives data from one or more other controllers or BMSs (e.g., the remote BMS 502), and aggregates data from multiple systems. In this manner, a user (e.g., in a supervisory role) may be provided with an overview of data from all of the buildings or sites managed by a single organization.

In some embodiments, receiving data (e.g., TPH data) from multiple sources or systems (e.g., a network of hospitals) can provide for a more robust data set that can be used to better understand problems and better maintain TPH compliance. In some embodiments, where the controller 620 predicts future non-compliance issues, as described below, the shared data can improve the accuracy of predictive models and therefore improve response of the controller 620 to TPH changes or issues.

In some embodiments, either prior to or after aggregating data from multiple sources, the data manager 632 can validate the data. Data validation may include, for example, ensuring that appropriate data is received, checking the data's type and structure, etc. It will be appreciated that any number of data validation rules may be applied based on individual implementations of the controller 620. Accordingly, the data manager 632 can validate any received data based on any number of validation rules.

In some embodiments, the data manager 632 is also configured to manage data storage and retrieval (i.e., data management). The data manager 632 may be configured to store received data in an internal database 642, for example. The internal database 642 may be a partition in the memory 630 or may be a separate memory device that is internal to the controller 620 and/or the BMS 400. In some embodiments, the data manager 632 may transmit data to one or more of the external databases 652, as previously described. In this regard, the data manager 632 may also retrieve data from either the internal database 642 or the external databases 652 for additional processing or analysis. The data management implemented by the data manager 632 is described in greater detail below at least with respect to FIG. 7.

The memory 630 is also shown to include a prediction generator 634. The prediction generator 634 is generally configured to analyze the previously received data to identify trends. In generally, the prediction generator 634 analyzes at least TPH data corresponding to a room (e.g., the room 600), area, or building. As described above, TPH data may include important parameters that indicate the environmental conditions of a room or area. TPH may be of particular importance for certain buildings, such as hospital, pharmaceutical produces, food preparation facilities, data centers, etc., that must maintain certain TPH to meet compliance standards.

The prediction generator 634 may be configured to generate trend data based on previously received sensor data corresponding to at least TPH of a room or building. In this regard, the prediction generator 634 may generate individual trend data for each room of a building. The sensor data may be analyzed to generate a trend in real time, or the prediction generator 634 may receive historical data from a database (e.g., the internal database 642 and/or the external databases 652) via the data manager 632. In either case, trend data is generated that indicates the TPH values of the room (e.g., the room 600) at a plurality of previous time steps. In other words, the trend data is time series data corresponding to TPH values for a room of a building.

In some embodiments, the prediction generator 634 implements a predictive model to generate a prediction of future trend data. The predictive model can be any suitable type of neural network, machine learning model, or other artificial intelligence system. In some embodiments, the predictive model may include a model based predictive engine based on previous data, decision trees, and other algorithms. The predictive model is generally selected or designed for a specific installation or building. For example, an artificial intelligence system may be structured to learn the specific TPH dynamics of a hospital area (e.g., patient rooms, operating rooms, commons paces, etc.). The prediction generator 634 may also be configured to continuously update the predictive model based on real-time senor data. In some embodiments, the predictive model is dynamically modified using a reinforcement learning schema to improve the accuracy of trend data predictions over time. In some embodiments, an initial policy is implemented within the predictive model based on historical data queried from the trend data, and the policy is updated over time using real time sensor data from the sensor array 602 and other information to learn the specific installation and improve functionality.

The memory 630 is also shown to include a compliance analyzer 636. The compliance analyzer 636 is structured to identify TPH compliance issues and compare information received from the sensor array 602 to compliance standards established by the TJC and the CMS. The compliance analyzer 636 is also generally configured to predict future non-compliance and thereby can initiate preventative maintenance to avoid compliance problems. The predictions of future compliance can be based on simple trend data, model predictive control, or artificial intelligence (e.g., neural networks, etc.). Accordingly, the functionality of the compliance analyzer 636 may closely intertwined with the prediction generator 634 in order to determine compliance.

In some embodiments, the compliance analyzer 636 can query a remote database (e.g., the external databases 652) or server (e.g., the servers 506) to retrieve stored compliance standards. In some such embodiments, the compliance analyzer 636 may query a third party system (e.g., the third party systems 504) in order to receive the most up-to-date compliance standards. For example, the compliance analyzer 636 may receive compliance standards directly from a server or website associated with TJC. In some embodiments, the compliance analyzer 636 may query an external system or database at a regular time interval, to maintain accurate compliance standards. As such, the compliance analyzer 636 may provide enhanced compliance analysis over other systems and methods by avoiding out-of-date standards. However, in certain other embodiments, compliance standards may be manually entered (e.g., by a user).

In some embodiments, the compliance analyzer 636 analyzes real-time or near real-time data received from one or more sensors (e.g., the sensor array 602) to detect compliance issues. In such embodiments, the compliance analyzer 636 may compare the TPH measurements from the sensor array 602 to a range of acceptable TPH values, as identified by the compliance standards. The TPH trend data for a room and/or building may be used to identify potential future non-compliance issues. TPH values that fall outside of an acceptable range may indicate non-compliance. In some embodiments, the compliance analyzer 636 may analyze actual trend data or predicted trend data generated by the prediction generator 634 to identify compliance issues. In such embodiments, the compliance analyzer 636 can predict future compliance issues based on the actual or predicted trend data.

In some embodiments, the compliance analyzer 636 may determine and/or initiate one or more automated response processes based on an indication of non-compliance or based on a prediction of future non-compliance. The automated response processes may include corrective actions that may be implemented to correct or prevent compliance issues. For example, the compliance analyzer 636 may cause the controller 620 to initiate operations of the supplementary system 606 to supplement or replace operations of the primary system 604. In some embodiments, the compliance analyzer 636 can initiate the generation of a work order indicating that a repair to equipment (e.g., of the primary system 604) may be required. In some such embodiments, the controller 620 may even automatically schedule maintenance or repairs for affected equipment.

In some embodiments, an indication of non-compliance or a prediction of future compliance issues may cause an alert generator 640 to generate an alarm or a notification. The alarm or notification may be provided (e.g., transmitted) to a user, a group of users, an outside or third party system, a vendor of a component, or another entity suitable to address an issue or problem that caused the generation of the alarm or notification. For example, the alert generator 640 may generate an alert or notification that indicates a room, building, or equipment that is out of compliance, or is at risk of falling out of compliance. The alert or notification may be automatically transmitted (e.g., via text message, voice call, email, push notification, etc.) to a device associated with a user (e.g., a facilities manager) or a group of users (e.g., a maintenance team) to indicate the users to the potential issue. In this regard, the alert generator 640 may be configured to query a database or remote system to identify communication information for one or more users (e.g., phone numbers, emails, etc.) to facilitate the transmission of an alert.

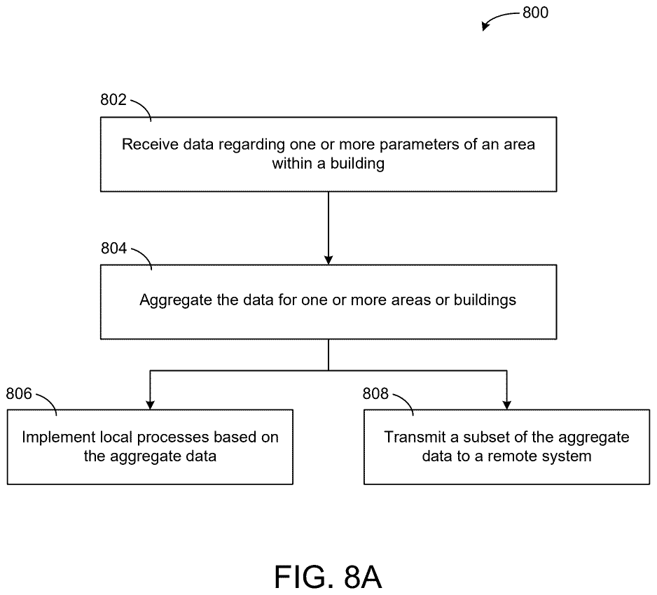

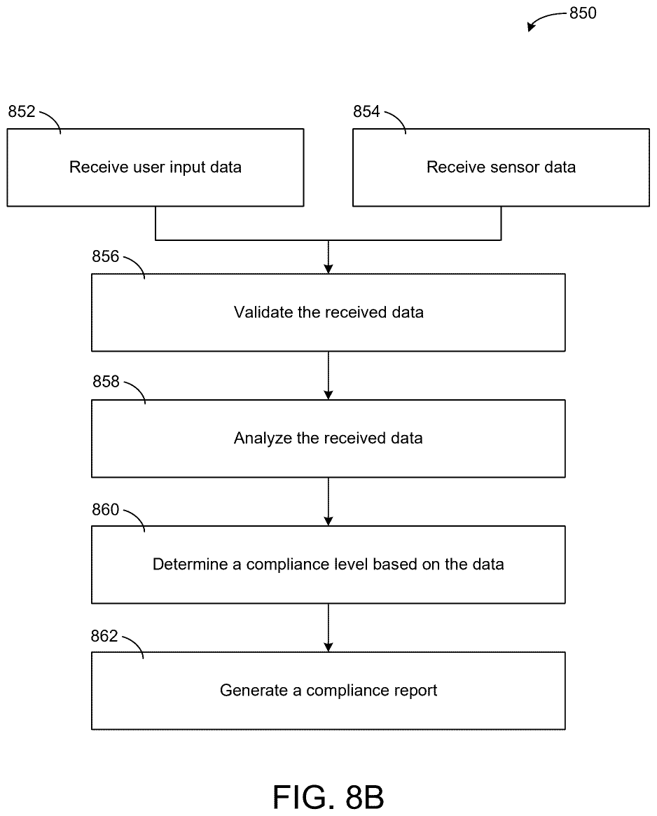

Still referring to FIG. 6B, the memory 630 is also shown to include a report generator 638. The report generator 638 is structured to generate a report indicative of compliance status of TPH and other factors. In some embodiments, the report generator 638 may determine a preferred report format from a third party system (e.g., CMS or TJC) including an indication of information required to show compliance and including a preferred format for the arrangement of the information. The report generator 638 may receive the report format and automatically populate a form or report to satisfy the compliance reporting requirements of the third party system. The generation of a compliance report is described in greater detail below with respect to FIG. 8B.

Referring now to FIG. 7, a block diagram of a data management system 700 for a building is shown, according to some embodiments. The system 700 may be implemented in a building served by the BMS 400, for example, and may allow for the storage and retrieval of any sort of operational data associated with a building. Data management is an especially important issue for a large scale BAS and/or BMS (e.g., the BMS 400). For example, compliance inspectors (e.g., a TJC inspector) may need to access to operational data (e.g., TPH for a room of the building) from varying historical time periods. In some embodiments, when a compliance issue has arisen, it can be useful to have access to historical operational data (e.g., operating parameters of HVAC equipment, control parameters and inputs, TPH logs, down times, corrective actions taken, etc.) in order to prevent future compliance issues, or to show that appropriate steps were taken to correct the compliance issue. The data management provided by the system 700 allows data (e.g., TPH data) to be accessed smoothly and quickly in the event of a compliance finding. The availability of a rich set of data allows the controller to better assess a root cause problem and provide a work order for fixing the problem quickly and efficiently.

As shown, the controller 620 is structured to receive data from sensor arrays 712-718 positioned in rooms 702-708. Each of the sensor arrays 712-718 may be similar or identical to the sensor array 602, described above. In this regard, each of the sensor arrays 712-718 may include any number of sensors for measuring parameters associated with an environment within a corresponding room. The sensor arrays 712-718 can include, for example, humidity sensors, temperature sensors, pressure sensors, fire/smoke alarms, door sensors, occupancy sensors, thermal cameras, air quality sensors, and/or other sensors that measure factors indicative of an environment within a room. Similarly, each of the rooms 702-708 may be similar or identical to the room 600. In some embodiments, the rooms 702-708 represent rooms or areas within a hospital (e.g., patient rooms, operating rooms, etc.). In some embodiments, the room 600 is a clean room for an industrial, food processing, or pharmaceutical process.

In some embodiments, the data measured by the sensor arrays 712-718 and subsequently transmitted to the controller 620 can include information related to an environment of a corresponding room (e.g., at least TPH measurements). In some embodiments, the controller 620 can also receive data corresponding to components of an HVAC system (e.g., HVAC system 440). In this regard, the controller 620 can not only record TPH measurements for a room (e.g., one of the rooms 702-708), but can also record operational data or operational states of HVAC equipment associated with the room (e.g., control outputs sent to a chiller or an air handling unit).

Information or data received by the controller 620 can subsequently be stored in local storage 720. The local storage 720 may include an integrated or removable storage/memory device that is local to a building served by the system 700 and/or the BMS 400. In one example, the local storage 720 may be the same as, or functionally equivalent to, the internal database 642 described above. As also described above, the data is generally at least TPH data corresponding to each of the rooms 702-708. In some embodiments, the data includes any operating parameters or environmental parameters related to system compliance.

In some embodiments, the data is maintained in the local storage 720 for a first predetermined time period (e.g., 24 hours, 30 days, 1 year, etc.). The first predetermined time period may be previously defined such as by a user or system manager, or may be automatically determined to provide rich data sets quickly, to facilitate the analysis of system parameters for operations or compliance. Storing data in the local storage 720 for at least the first predetermined time period can allow for fast and thorough access (e.g., by the components of controller 620) to a large set of stored information. For example, locally stored data may be accessed more quickly than remotely stored data, and is thereby more readily available for analysis by controller 620. In some cases, the local storage 720 allows for real-time data access to facilitate the analyses performed by controller 620, as described with respect to FIGS. 8A-10. In this regard, the data stored in the local storage 720 may be used to determine automated or semi-automated control decisions, or other response processes.

In some embodiments, locally stored data may also be more robust than remotely stored data. For example, data stored in the local storage 720 may include raw and/or preprocessed sensor data that includes a very large number of data points, time steps, or values. In some cases, this sensor data may need to be compressed, modified, or otherwise altered to reduce the data size for remote storage (e.g., to save space), resulting in less robust data sets. In some embodiments, the local storage 720 also allows a user (e.g., of user device 654) to quickly and easily access these full, robust data sets in order to make operational adjustments, control decisions, analyze compliance or efficiency, etc.

After the first predetermined time period, at least a portion of the data can be assembled into packets and transmitted to remote storage 730 (e.g., the external databases 652) for long term storage. Similar to the local storage 720, the remote storage 730 may include any storage or memory device that is remote from a building that includes the rooms 702-708 and/or the controller 620. In one example, the remote storage 730 may be the same as, or functionally equivalent to, the external databases 652 described above. The long term data storage in the form of the remote storage 730 can maintain the data packets for accessibility upon request for a second predetermined time period (e.g., 1 year, 10 years, three TJC inspection periods, etc.). In some embodiments, the first time period is at least two compliance inspections cycles, as established by TJC, or about three months, and the second predetermine time period is at least one year. In some embodiments, the second predetermined time period is at least three years. Other time periods are contemplated and the time periods may be set based on the individual needs of a system or building, or may be determined by TJC or CMS.

FIG. 8A is a flow diagram of a process 800 for aggregating data from one or more areas of a building or among multiple buildings, according to some embodiments. The process 800 can be implemented by the controller 620, for example. Data, typically including at least TPH data for a room or rooms of a building, can be received and aggregated from a network of buildings (e.g., hospitals) to improve control algorithms and predictive models, and can also be sold or used as a data source. In some embodiments, such as in a hospital setting, the aggregated information can include relevant patient outcomes correlated to TPH compliance, and other TPH related information gathered by a network of hospitals. It will be appreciated that certain steps of the process 800 may be optional and, in some embodiments, the process 800 may be implemented using less than all of the steps.

At step 802, data relating to one or more parameters of an area (e.g., a room) within a building is received. As described above with respect to FIG. 6, for example, data may include a variety of measurements captured by one or more sensors of a sensor array that indicate at least the TPH of a room. In some embodiments, the data may be received directly from a sensor array (e.g., the sensor array 602), but in other embodiments, the data may be received via a user input to a user device (e.g., a tablet or computer). In some embodiments, data may be received from a plurality of sensor arrays (e.g., the sensor arrays 712-718) corresponding to a plurality of rooms (e.g. the rooms 702-708) of a building (e.g., a hospital). In some embodiments, data is received from multiple buildings, BMSs, and/or building subsystems.

At step 804, the received data is aggregated for one or more areas or buildings. In some embodiments, data from one or more buildings, BMSs, and/or subsystems may be aggregated for a site or organization. For example, a single organization may own, operate, or monitor a plurality of buildings and may aggregate data received from each of the buildings. In another example, TPH data received from multiple hospitals may be aggregated into a single data set. In any case, data from multiple sources (e.g., sensor arrays, controllers, BMSs, etc.) may be aggregated to produce a complete data set for an organization or building.

At step 806, one or more local process can be implemented based on the aggregate data. The local process can include any of the processes described below with respect to FIGS. 8B-10, for example. Local processes may include, for example, processing, analyzing, and/or storing the data to determine trend data and to identify or predict compliance issues. In some embodiments, such as for a hospital or a group of hospitals, the aggregate data can also be analyzed (e.g., by the controller 620) to statistically correlate patient outcomes to the aggregate data. For example, aggregate TPH data may be analyzed to determine an impact or correlation between a room TPH and a patient outcome.

At step 808, a subset of the aggregate data may be transmitted to a remote system. In some embodiments, the step 808 may be implemented concurrently with the step 806. In other embodiments, one of the steps 806 or the steps 808 may be implemented before the other. The subset of aggregate data may include a copy of at least a portion of the aggregate data, for example. In some embodiments, the subset of aggregate data may be transmitted to an external or remote system for oversight or additional monitoring. In some embodiments, the subset of aggregate data may be sold to a third party. For example, the data may be sold to an insurance company to negotiate a reduced insurance rate based on demonstrated compliance and correlated successful patient outcomes. Accordingly, for a hospital, a compliance cost savings may be calculated based at least in part on the aggregate information and the historical statistics. In some embodiments, a price of the aggregated data may be determined (e.g., by the controller 620) prior to sale. In this regard, the sale of aggregate data may increase revenue and/or decrease operating costs for a system.

In some embodiments, the aggregate data can be utilized to determine the trends or tendencies of individual users, or of groups of users. For example, in a hospital setting, the aggregate data may provide insight into the tendencies of a particular surgeon by comparing the TPH setpoints of an operating room with the surgeon's success rate. In another example, the aggregate data may be utilized to automatically set the TPH setpoints of a room based on the schedule of a user. For example, a schedule for an area or room (e.g., a patient room, an operating room) may indicate when the space will be in use, and may also define TPH setpoint for the period of use. In this example, a user (e.g., a nurse) may manually input (e.g., via user device 654) particular TPH parameters or setpoints, along with a start and a stop time, and the system (e.g., controller 620) may automatically control HVAC equipment based on the setpoints during the predetermined time period. In other embodiments, a third party scheduling system may be queried (e.g., via a secure interface) to determine an area's schedule and corresponding setpoints.

In some embodiments, the aggregate data can identify operational dependencies. For example, the aggregate data may be purchased by a manufacturer of HVAC equipment to improve future equipment designs, and to identify how equipment interacts to affect an environment. In some embodiments, the aggregate data can be used to improve efficiency. A hospital, for example, could use the aggregate data to improve energy efficiency by identifying TPH trends, or a company that constructs or designs hospitals could utilize the aggregate data to improve future building design and efficiency. Additionally, the aggregate data could be used to identify user preferences. For example, in a retail environment, the data could be used to determine comfortable TPH settings to improve a customer's experience.

FIG. 8B is a flow diagram of a process 850 for analyzing data for at least one area of a building, according to some embodiments. The process 850 can be implemented by the controller 620, for example. In general, the process 850 follows the flow of data, typically TPH data, for a room or building. In other words, the process 850 may provide a high-level overview of TPH data analysis for a room or building. It will be appreciated that certain steps of the process 850 may be optional and, in some embodiments, the process 850 may be implemented using less than all of the steps.

At step 852, data is received via a user input to a user device. As described above, for example, the user device (e.g., user device 654) may include a personal computer, a smart phone, a tablet, etc., that provides a user interface for accepting user inputs. In general, the user inputs include TPH values for a room of a building. Accordingly, the user interface presented via the user device may allow the user to indicate a room number, building, floor, or other identifier for the room. In one example, for a hospital, a user such as a nurse may manually enter TPH measurements via a portable user device (e.g., a table) when entering a room. The data may subsequently be automatically uploaded to a database and/or the controller 620.

At step 854, sensor data is received from a sensor array (e.g., the sensor array 602). In some embodiments, the step 854 may be implemented concurrently with the step 852. In other embodiments, one of the steps 852 or the steps 854 may be implemented before the other. It will also be appreciated that, in some cases, the step 852 is an optional step, and that no data may be received via user input. As described above with respect to FIG. 6, for example, sensor data may include a variety of measurements captured by one or more sensors of a sensor array (e.g., the sensor array 602) that indicate at least the TPH of a room. In some embodiments, data may be received from a plurality of sensor arrays (e.g., the sensor arrays 712-718) corresponding to a plurality of rooms (e.g. the rooms 702-708) of a building (e.g., a hospital).

At step 856, the received data is validated. It will be appreciated that any number of data validation rules may be applied based on individual implementations. Validation may include, for example, ensuring that appropriate data is received, checking the data's type and structure, etc. In some embodiments, validation includes converting data from a first format to a second format. In some embodiments, validation includes checking for corrupt data.

At step 858, the received data is analyzed. As briefly described above, analyzing the data may include comparing the data to compliance standards to determine if one or more parameters are out of compliance. A non-compliant parameter may indicate a problem with building equipment associated with the parameter. For example, non-compliant room temperature may indicate a faulty AHU. In this regard, the data may be analyzed in real-time to detect compliance issues as they occur. In some embodiments, TPH data is analyzed by comparing the TPH to acceptable ranges of values, as defined by a compliance governing body. For example, an acceptable humidity range for a patient room may be 40-60%. If TPH indicates a humidity outside of this range, the room may be non-compliant.

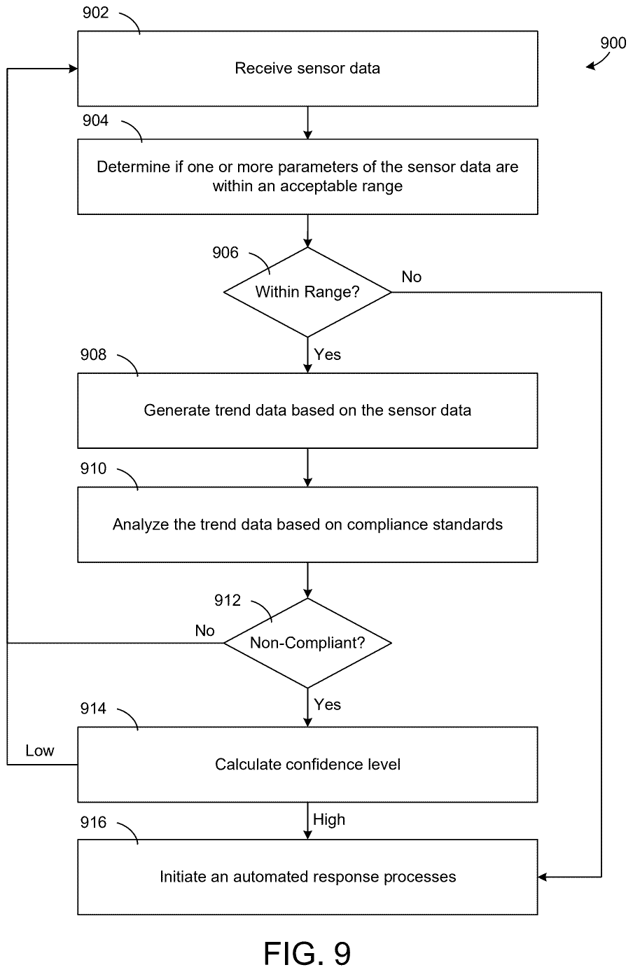

In some embodiments, data analysis include generating trend data for the room or building. As previously described, the trend data may indicating TPH measurements for the room or building at a plurality of time intervals of a period of time. The trend data may also be utilized to predict future compliance issues. For example, a downward trend in temperature values may indicate that a heater is struggling to provide an appropriate amount of warm air. Accordingly, predicted future trend data may be used to predict future compliance. The analysis of the data is described in greater detail below with respect to FIG. 9.

At step 860, a compliance level is determined for the room, building, system, etc., based on the data. In some embodiments, the compliance level simply indicates where one or more parameters of the TPH data are within a compliance range by comparing the measured TPH data and/or the trend data to a compliance standard, as described above. In such embodiments, the compliance level indicates whether or not the room, building, or equipment is completely compliant. In some embodiments, the compliance level for a room or building may be presented using a range. For example, the compliance level may be assigned a letter grade (e.g., A through F) or a color (e.g., green, yellow, red). In this case, the compliance level may be determined based on multiple parameters. For example, if a single one of the TPH value is non-compliant, the compliance level may be “yellow” while a “red” level may indicate that two more TPH values are non-compliant. In another example, a building may be assigned a compliance grade of a C if a certain percentage of rooms are non-compliant.

At step 862, a compliance report is generated. As described above, for example, the report generator 638 may generate a compliance report that summarizes TPH compliance for one or more rooms monitored by the controller 620. In some embodiments, the compliance report format is received/retrieved from a from a third party system (e.g., CMS or TJC), and can include an indication of information required to show compliance and a preferred format for the arrangement of the information. The report may include, for example, an indication of TPH for one or more rooms of a building, and may also indicate a time stamp associated with the TPH measurements. In some cases, the report may also include notes (e.g., input by a user) and/or an indication of a corrective action that was implemented in the event of non-compliance. The compliance report may be automatically populated with relevant data to satisfy the compliance reporting requirements of the third party system.

In some embodiments, the compliance report is separated into different sections detailing rooms by type, use, or other organizations categories, as desired by the third party system. In some embodiments, the report can include compliance problems identified and the corrective action taken to maintain parameter (e.g., TPH) within compliance. The report can include predictive information and preventative maintenance performed to maintain the TPH in compliance.

In some embodiments, the compliance report is generated in a portable document format (PDF), although it will be appreciated that any suitable format may be used. The compliance report may be generated dynamically, in response to a user request, or may be generated at a regular time interval. Accordingly, in some cases, previously generated reports may be stored in a database (e.g., the internal database 642 or the external databases 652). In some embodiments, the compliance report may be automatically or manually distributed to an inspector (e.g., via a third party system). In some such embodiments, the controller 620 may be configured to allow a third party system (e.g., the third party systems 504) to query information directly from the report generator 638 and the internal database 642. In some embodiments, the third party system may access compliance reports from the external databases 652.

FIG. 9 is a flow diagram of a process 900 for monitoring compliance of a BMS subsystem, according to some embodiments. Like the other processes described herein, the process 900 can be implemented by the controller 620. When implemented by a controller such as the controller 620, the process 900 may, beneficially, automate at least a portion of the steps required to determine compliance for a building and/or a BMS. Additionally, the process 900 may allow for the prediction of potential compliance issues, which may in turn allow for preemptive maintenance or corrective actions to avoid these compliance issues. Accordingly, by implementing the process 900, a system (e.g., the BMS 400) may experience less down time due to compliance issues or equipment problems and may maintain compliance for longer periods of time. In this regard, the process 900 may provide a better and safer experience for occupants of a building (e.g., patients in a hospital). It will be appreciated that certain steps of the process 900 may be optional and, in some embodiments, the process 900 may be implemented using less than all of the steps.

At step 902, sensor data is received. In some embodiments, step 902 may be substantially similar to the steps 802, 852, and/or 854, as described above. In other words, the sensor data may relate to one or more parameters of an area (e.g., a room) within a building, and generally includes at least TPH measurements for the room. The sensor data may be received from a sensor array (e.g., the sensor array 602) located within a particular room (e.g., the room 600). In some embodiments, the data may be received directly from a sensor array (e.g., the sensor array 602), but in other embodiments, the data may be received via a user input to a user device (e.g., a tablet or computer).

At step 904, the sensor data is analyzed to determine if one or more parameters are within an acceptable range. In some embodiments, the range of acceptable parameters includes ranges for each of TPH for a room. The range may be determined by a compliance standard received or retrieved from a third party such as TJC or CMS. In this regard, the range may indicate an upper and a lower threshold feature for each of the TPH for a room. If the sensor data for the room indicates a TPH within the range, the sensor data or room may be deemed compliant and the process 900 may continue to the step 908. In the event that one or more of the TPH is not within a corresponding range, the sensor data or room may be deemed non-compliant. Accordingly, the process 900 may continue to the step 916, described in detail below.

In some embodiments, compliance standards are received from a remote database (e.g., the external databases 652) or server (e.g., the servers 506) associate with a governing body such as TJC or CMS. In this regard, the compliance standards may be continuously or dynamically updated. For example, new compliance standards may be retrieved at a regular time interval to maintain accurate compliance standards. In another example, compliance standards stored or referenced by the controller 620 may be updated in response to TJC or CMS updating the compliance standards. In other embodiments, compliance standards may be manually entered (e.g., by a user).

At step 908, trend data is generated based on the sensor data. As described above, the trend data generally indicates the TPH values of the room (e.g., the room 600) for each of a plurality of previous time steps over a time period. In other words, the trend data is time series data corresponding to TPH values for a room or area of a building. In some embodiments, the trend data is generated using historical sensor data that is retrieved from a database (e.g., the internal database 642 or the external databases 652). In this regard, the trend data may be dynamically generated or updated as new sensor data is received.

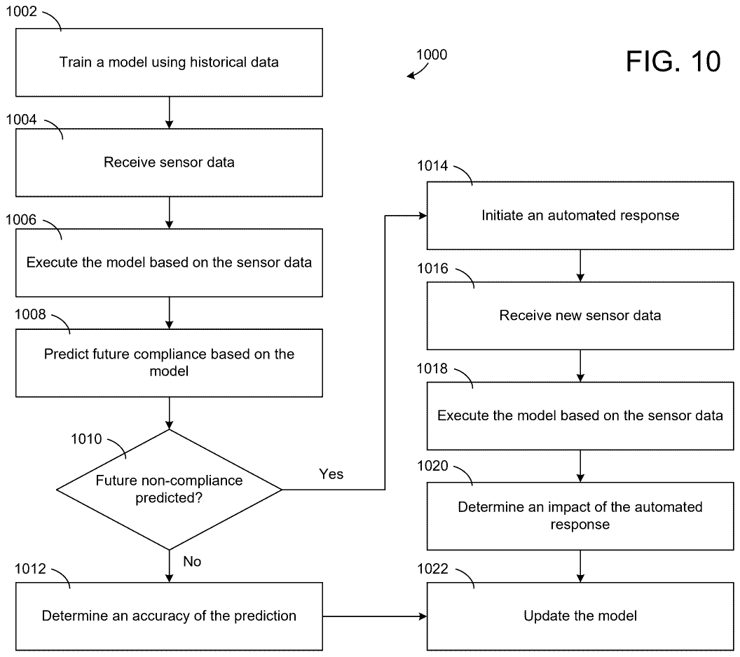

In some embodiments, a predictive model is used to generate a prediction of future trend data. The predictive model can be any suitable type of neural network, machine learning model, or other artificial intelligence system. The model predictive is generally selected or designed for a specific installation (i.e., a particular building), and may be configured for the TPH dynamics of the particular building. In some embodiments, the predicative model (e.g., an artificial intelligence system) may be structured to learn the specific TPH dynamics of a building over time. In this regard, the predicative model may also be dynamically or continuously updated as new senor data is received. In some embodiments, as described in greater detail below, the predictive model is dynamically modified using a reinforcement learning schema to improve the accuracy of trend data predictions over time. The generation of a prediction of future trend data and/or future compliance issues is described in greater detail with respect to FIG. 10.

At step 910, the trend data is analyzed based on the compliance standards. In other words, the trend data and predicted trend data may be analyzed to determine if one or more parameters (e.g., one of TPH) is trending in a manner that indicates future compliance issues. Predicted trend data, for example, may indicate whether one or more of TPH could become non-compliant in the near future (e.g., within a future time period). In some embodiments, the trend data may be analyzed using a machine learning algorithm, a neural network, an artificial intelligence system, as described below with respect to FIG. 10, or by another method to generate a prediction of future compliance for a room or building. If future non-compliance is predicted based on the trend data, the process 900 may continue to the step 914. If the TPH for the room or building is predicted to remain compliant, at least for a predefined future time period, then the process 900 may restart back at the step 902.

At step 914, a confidence level is calculated for the compliance determination. The confidence level may generally indicate an accuracy of the predicated future compliance. In other words, a high confidence level may indicate that the prediction is likely correct, whereas a low confidence level may indicate that the predication may be incorrect. In embodiments, the confidence level may be represented as a percentage (e.g., where 100% indicates a completely accurate prediction), a number value, etc. In such embodiments, the confidence level may be compared to a threshold, where a prediction with a confidence level over the threshold is assumed to be correct and a prediction with a confidence level below the threshold is assumed to be incorrect. In the first case, with a high confidence level, the process 900 may continue to step 916. If the confidence level is determined to be too low, the process 900 may restart at the step 902.

At step 916, automated response processes are initiated. As described above, the automated response processes may include corrective actions that may be implemented to correct non-compliance or to prevent predicted compliance issues. In some embodiments, the automated response processes include controlling building equipment (e.g., HVAC equipment) in order to affect at least one of the TPH for a room or building. For example, the automated response process may include adjusting a setpoint, increasing the output of a building device, activating additional equipment to supplement a primary device, etc. In some embodiments, controlling the building equipment may include activating (e.g., controlling) one or more supplementary or complementary systems in order to provide additional capacity or additional functionality to a primary system. For example, if a component of a primary system fails, which causes a compliance issue, a supplementary system that is substantially similar to the primary system may be active to correct the issue. In any case, the equipment may be controlled to bring the TPH for the room back into compliance.

In some embodiments, the automated response processes include the generation of a work order. The work order may indicate that a repair to equipment may be required to correct or prevent compliance issues. In some embodiments, the work order may indicate at least an identifier associated with affected equipment, and in some cases may indicate a type of service to be performed. In some embodiments, the automated response processes may also include scheduling maintenance or repairs for affected equipment. The work order and/or maintenance request can be transmitted to a separate work order or maintenance system, or may be transmitted directly to one or more users (e.g., maintenance technicians). In this regard, the work order may allow for the one or more users to initiate additional response processes to mitigate and/or quickly resolve compliance issues.

In some embodiments, the automated response processes include the generation of an alarm or a notification. The alarm or notification may be provided (e.g., transmitted) to a user, a group of users, an outside or third party system, a vendor of a component, or another entity suitable to address an issue or problem that caused the generation of the alarm or notification. In some embodiments, the alert or notification may indicate detected or predicted compliance issues and may even indicate a room, building, or equipment associated with the issue. The alert or notification may be automatically transmitted (e.g., via text message, voice call, email, push notification, etc.) to a device associated with a user (e.g., a facilities manager) or a group of users (e.g., a maintenance team) to indicate the users to the potential issue.

In some embodiments, the automated response process includes generating a report. The report may be similar to a compliance report, as described above. The report may indicate, for example, a summary of the trend data and/or the trend data analysis. In some cases, the report may also indicate a location or indicator of a room or building that is non-compliant. When a compliance issue is predicted based on trend data, rather than detected from sensor data, the report may also include an indication of when the compliance issue may occur. In some embodiments, the report includes a time range or an indication of a time period when the compliance issues are expected to occur.

FIG. 10 is a flow diagram of a process 1000 for predicting non-compliance of BMS subsystems using a predictive model, according to some embodiments. Like the other processes described herein, the process 1000 can be implemented by the controller 620. Generally, the process 1000 facilitates the prediction of potential, future compliance issues by analyzing sensor data using a predictive model. As describe above, the predictive model described herein can be any suitable type of neural network, machine learning model, or other artificial intelligence system. The model predictive is generally selected or designed for a specific installation (i.e., a particular building), and may be configured for the TPH dynamics of the particular building. In some embodiments, the predicative model (e.g., an artificial intelligence system) may be structured to learn the specific TPH dynamics of a building over time.

By predicting compliance issues early, equipment associated with non-compliant parameters may be repaired, maintained, or adjusted to prevent the compliance issues. This may result in less down time for the equipment and, in some cases, reduced repair costs. Additionally, preventing future compliance issues may help a facility or organization avoid costly penalties, increased insurance, etc. In some cases, such as in a hospital setting, decreased compliance issues may also lead to more positive patient outcomes and an overall better patient experience. It will be appreciated that certain steps of the process 1000 may be optional and, in some embodiments, the process 1000 may be implemented using less than all of the steps.

At step 1002, a predictive model is trained using historical data. The historical data may include any previous recorded data corresponding to parameters of a room or building, including at least TPH data. The historical data may be retrieved from a database (e.g., the internal database 642 and/or the external databases 652) when initializing the model for training. In some embodiments, the historical data is divided into a training set and a test set, where the training set is used to train and tune the model (e.g., the weights and other parameters of the model) to identify compliance issues and/or to predict future trend data. The test set may be used to validate the training of the model and/or to further fine-tune the model.

At step 1004, sensor data is received. In some embodiments, the step 1002 may be substantially similar to any of the steps 802, 852, 854, and/or 902 as described above. In other words, the sensor data may relate to one or more parameters of an area (e.g., a room) within a building, and generally includes at least TPH measurements for the room. The sensor data may be received from a sensor array (e.g., the sensor array 602) located within a particular room (e.g., the room 600). In some embodiments, the data may be received directly from a sensor array (e.g., the sensor array 602), but in other embodiments, the data may be received via a user input to a user device (e.g., a tablet or computer).

At step 1006, the predictive model is executed using the sensor data. The sensor data may be fed into the trained predictive model to generate an output data set. The output of the model can be predicted future trend data and/or predicted future sensor data values. In some embodiments, the output includes at least predicted future TPH values (i.e., the trend data). In this regard, the predictive model may also be executed based on previously received and/or analyzed sensor data, and/or other historical TPH data. The predicted future trend data generally indicates predicted values for at least one of a temperature, pressure, or humidity (TPH) for a room or building at one or more future time steps of a time horizon. In some embodiments, the predictive model may also generate and/or indicate a confidence score for the prediction. Similar to the step 914, above, the confidence score may indicate a likelihood of the prediction coming to fruition. In other words, the confidence score may indicate how reliable a prediction may be.

At step 1008, future compliance is predicted based on the predictive model. Future compliance may be predicted by analyzing the predicted trend data in a similar manner to the step 910, above. For example, the future trend data can be analyzed to determine if the predicted TPH trend data is moving towards the upper and/or lower limits of a threshold range. As described above, acceptable compliance values may be determined from previously received compliance standards. In this regard, the predicted trend data may be compared to the compliance standards to determine if, at any point in a future time period, the trend data (e.g., one of TPH) is predicted to exceed the compliance standards.

In some embodiments, the predicted trend data is passed through a second predictive model to identify potential compliance issues. In this case, the second model may be configured to identify predictors of future non-compliance based on predicted trend data and/or sensor data. Accordingly, the second model may output a prediction of compliance (e.g., a compliance level). In some embodiments, a confidence level for the prediction at the step 1006 may also be utilized to determine future compliance. For example, a high confidence score, which indicates a high likelihood of the prediction, may be used while a low confidence score, indicating uncertainty in the prediction, may be ignored. In some embodiments, the confidence score for the prediction may be compared to a threshold, where only confidence scores above the threshold are determined to be usable. If future compliance issues are predicted, the process 1000 may continue to the step 1014. If no compliance issues are predicted, the process 1000 may continue to the step 1012.

At step 1012, the accuracy of the prediction is determined. The accuracy may be determined by analyzing subsequently received sensor data to determine if, in fact, compliance issues were avoided. In some embodiments, an expert user may manually review predictions and associated confidence values, and/or sensor data to determine whether the predictive model is making accurate predictions. It will be appreciated, however, that other methods of determining the accuracy of the predictive model are contemplated herein. In some embodiments, a high accuracy value may indicate that the predictive model is making very accurate predictions. For example, if the prediction indicates that there is a low likelihood for compliance issues, and no compliance issues occur within a future time period, then the prediction may be highly accurate. A low accuracy value may indicate that the prediction was incorrect, and the model may need to be adjusted.

At step 1014, an automated response process is initiated. In this regard, the step 1014 may be substantially similar to the step 916, described above. The automated response process may include, for example, controlling building equipment (e.g., an HVAC device) to adjust an output, such as by increasing capacity, changing a setpoint, activating a second (e.g., supplementary) system, etc. In some embodiments, the automated response process includes automatically generating a work order and/or scheduling maintenance or repairs. In some embodiments, the automated response process may be as simple as generating and transmitting an alert or a notification.

At step 1016, new sensor data is received. The step 1016 may be substantially similar to the step 1004, in some cases. In other words, the new sensor data generally includes the same type of data received at the step 1004, however, the new sensor data is received after initiating a response process at the step 1014. In some embodiments, this means that the new sensor data may be associated with TPH values collected after equipment is repaired or after one or more devices are controlled to affect an out.

At step 1018, the predictive model is executed using the new sensor data, in a manner similar to the step 1006. In this regard, the predictive model may generate new predicted trend data based on the new sensor data. Subsequently, at the the step 1020, the new predicted trend data can be analyzed (e.g., compared to a compliance standard) to determine an impact of the automated response process. In some embodiments, the analysis determines whether the new predicted trend data is improved over the trend data predicted at the step 1006. In this regard, the analysis of the new trend data may determine whether predicted future compliance issues have been resolved. For example, if the previously predicted trend data indicates predicted future non-compliance and the new predicted trend data does not, the automated response process may be deemed as having a positive impact. More generally, the new trend data may be analyzed to determine whether the automated response process has a positive or a negative impact with respect to prevent future compliance issues.

At step 1022, the predictive model is updated. Updating the model may increase the speed and accuracy of the model over time, by comparing the accuracy of a prediction to an actual result or by identifying positive or negative impacts of a response process. In some embodiments, the predictive model is dynamically updated or improved through reinforcement learning. Reinforcement learning can include generating a reward value based on either the prediction made by the predictive model (e.g., at the step 1008) and the accuracy of the prediction, or the impact of the automated response processes.

As an example, an automated response process that is determined to have a positive impact on correcting future compliance issues may be assigned a large or positive (e.g., when compared to an initial, baseline, or previous reward value) reward value. In another example, a prediction that is determined to be inaccurate may be assigned a small or negative reward value. Accordingly, large or positive reward values may indicate a “good” prediction or automated response that can be repeated or reused in the future for similar condition. When a reward value is negative or small, the associated prediction of response process may be identified as “bad”, and the predictive model may be adjusted accordingly.

### Configuration of Exemplary Embodiments

The construction and arrangement of the systems and methods as shown in the exemplary embodiments are illustrative only. Although only a few embodiments have been described in detail in this disclosure, many modifications are possible (e.g., variations in sizes, dimensions, structures, shapes and proportions of the elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the connection steps, processing steps, comparison steps and decision steps.

1. A building management system (BMS) comprising:
a sensor array structured to provide sensor data indicative of temperature, pressure, and humidity in an interior space; and
one or more processing circuits comprising one or more memory devices coupled to one or more processors, the one or more memory devices configured to store instructions thereon that, when executed by the one or more processors, cause the one or more processors to:
receive the sensor data from the sensor array,
generate, based on the sensor data, trend data indicative of the temperature, pressure, and humidity of the interior space over a period of time,
generate, based on the trend data, a prediction of future trend data for the interior space,
receive a compliance standard defined by a third-party, wherein the compliance standard includes a plurality of non-manual entry setpoints,
compare at least one of the sensor data or the prediction to the plurality of non-manual entry setpoints of the compliance standard,
receive scheduling data including at least one scheduled event associated with the interior of the space, and
initiate an automated response process in response to a determining that at least one of the sensor data or the prediction does not meet the compliance standard, the automated response process comprising controlling one or more primary building devices to affect at least one of the temperature, pressure, or humidity of the interior space to ensure the at least one of the temperature, pressure, or humidity of the interior space is within the compliance standard while avoiding a conflict with the at least one scheduled event associated with the interior of the space.

2. The BMS of claim 1, wherein the one or more memory devices are further configured to store instructions thereon that, when executed by the one or more processors, cause the one or more processors to:
determine a confidence level for the prediction, and
compare the confidence level to a predetermined threshold, and
wherein the automated response process is initiated when the confidence level is greater than or equal to the predetermined threshold.

3. The BMS of claim 1, wherein the one or more memory devices are further configured to store instructions thereon that, when executed by the one or more processors, cause the one or more processors to generate a report summarizing the trend data and providing a time range when the sensor data is predicted to not meet the compliance standard.

4. The BMS of claim 1, wherein the automated response process includes:
generating a notification that indicates at least one building device associated with the at least one of the sensor data or the prediction that does not meet the compliance standard, and
transmitting the notification to a user device.

5. The BMS of claim 1, wherein the automated response process includes:
generating a work order for at least one building device associated with the at least one of the sensor data or the prediction that does not meet the compliance standard, and
transmitting the work order to at least one of a remote system or a user device.

6. The BMS of claim 1, wherein generating the prediction includes:
executing a predictive model to generate a first prediction of future trend data, and
determining, based on the first prediction of future trend data, a second prediction indicating a future compliance issue for a building device.

7. The BMS of claim 6, wherein the sensor data is first sensor data, and wherein the one or more memory devices are further configured to store instructions thereon that, when executed by the one or more processors, cause the one or more processors to:
receive second sensor data from the sensor array after initiating the automated control action,
compare the second sensor data to the compliance standard to determine a reward value, and
update the predictive model based on the reward value.

8. The BMS of claim 6, wherein the one or more memory devices are further configured to store instructions thereon that, when executed by the one or more processors, cause the one or more processors to train the predictive model using historical temperature, pressure, and humidity data for the interior space.

9. The BMS of claim 1, wherein the compliance standard is at least one of a regulatory standard, a government standard, or a medical services standard.

10. A method for maintaining compliance of building equipment in a building management system (BMS), the method comprising:
receiving sensor data from a sensor array located in an area of a building;
generating, based on the sensor data, trend data indicative of the temperature, pressure, and humidity of the area over a period of time;
generating, based on the trend data, a prediction of future trend data for the area;
receiving a compliance standard defined by a third-party, wherein the compliance standard includes a plurality of non-manual entry setpoints;
comparing at least one of the sensor data or the prediction to the plurality of non-manual entry setpoints of the compliance standard;
receiving scheduling data including at least one scheduled event associated with the area; and
initiating an automated response process in response to a determining that at least one of the sensor data or the prediction does not meet the compliance standard, the automated response including a preemptive action that controls a heating, ventilation, or air conditioning system based on the trend data to maintain the temperature, pressure, and humidity within the compliance standard while avoiding a conflict with the at least one scheduled event associated with the area.

11. The method of claim 10, further comprising:
determining a confidence level for the prediction; and
comparing the confidence level to a predetermined threshold;
wherein the preemptive action is initiated when the confidence level is greater than or equal to the predetermined threshold.

12. The method of claim 10, further comprising generating a report summarizing the trend data and providing a time range when the sensor data is predicted to not meet the compliance standard.

13. The method of claim 10, wherein the preemptive action includes controlling one or more primary building devices to alter operation before the temperature, pressure, or humidity of the area is outside the compliance standard.

14. The method of claim 10, wherein the automated response process includes:
generating a notification that indicates at least one building device associated with the at least one of the sensor data or the prediction that does not meet the compliance standard; and
transmitting the notification to a user device.

15. The method of claim 10, wherein the automated response process includes:
generating a work order for at least one building device associated with the at least one of the sensor data or the prediction that does not meet the compliance standard; and
transmitting the work order to at least one of a remote system or a user device.

16. The method of claim 10, wherein generating the prediction includes:
executing a predictive model to generate a first prediction of future trend data; and
determining, based on the first prediction of future trend data, a second prediction indicating a future compliance issue for a building device.

17. The method of claim 16, wherein the sensor data is first sensor data, the method further including:
controlling one or more primary building devices based on at least one of the sensor data or the prediction;
receiving second sensor data from the sensor array after controlling the one or more primary building devices;
comparing the second sensor data to the compliance standard to determine a reward value; and
updating the predictive model based on the reward value.

18. The method of claim 16, further comprising training the predictive model using historical temperature, pressure, and humidity data for the area.

19. A non-transitory computer-readable storage media having computer-executable instructions stored thereon that, when executed by one or more processors, cause the one or more processors to perform operations comprising:
receiving sensor information over time from a sensor array located in an interior space of a building;
receiving operational parameters from one or more primary building devices;
generating trend data indicative of the temperature, pressure, and humidity of the interior space over a period of time using a machine learning engine that receives the sensor information and the operational parameters;
generating a future trend prediction of future trend data for the interior space using the machine learning engine;
comparing the future trend prediction to a compliance standard;
generating a predicted future compliance issue based on the comparison of the future trend prediction to the compliance standard;
determining a confidence level for the predicted future compliance issue;
receive scheduling data including at least one scheduled event associated with the interior of the space; and
in response to a determination that the confidence level is greater than or equal to a predetermined threshold, initiating an automated response process to ensure the at least one of the temperature, pressure, or humidity of the interior space is within the compliance standard while avoiding a conflict with the at least one scheduled event associated with the interior of the space.

20. The storage media of claim 19, wherein the automated response process includes at least one of:
transmitting a notification to a user device;
generating a work order for one or more building devices associated with the predicted future compliance issue; or
controlling the one or more building devices to prevent the predicted future compliance issue.
